(19) United States
(12) Patent Application Publication
(10) Pub. No.: US 2005/0112526 A1
(43) Pub. Date: May 26, 2005

(54) Dental hand piece

(76) Inventors: Chii-Ron Kuo, Hsinchu (TW); Tzeng-Wuu Wey, Hsinchu Hsien (TW); Chia-Yang Chang, Tu-Cheng City (TW)

Correspondence Address: PRO-TECHTOR INTERNATIONAL, 20775 Norada Court, Saratoga, CA, 95070-3018, US

(21) Appl. No.: 10/785,592

(22) Filed: Feb. 23, 2004

(30) Foreign Application Priority Data
Nov. 26, 2003 (TW) SN.092133256

(51) Int. Cl. A61C 1/08

(52) U.S. Cl. 433/132

(57) ABSTRACT

A dental hand piece, comprising a casing, an axis, front and rear bearings, a turbine, a front lid, and a drill head. Air of high pressure enters the casing through an air inlet, is led through a front ring channel, hits the air turbine in an axial direction, driving a rotational movement of the air turbine, passes through a rear ring channel and leaves the casing through an air outlet. A path for fluids from the drill head to reach the air outlet is blocked, effectivity of driving is increased, and noise is reduced.

### BACKGROUND OF THE INVENTION

1. Field of the Invention

The present invention relates to a dental hand piece, particularly to a dental hand piece using compressed air and having a high-pressure sealing ring to isolate a drill head from air backflow, so that sucking back of air is prevented, power is increased and noise is reduced.

2. Description of Related Art

During dental treatment, air circulates at high speed. Any backflow of air from a patient's mouth possibly carries germs and viruses along, spreading deseases like hepatitis B or Aids and infecting previously disinfected fluids and drill heads. Samples of untreated water contain ten thousands of germs per milliliter. Germs tend to adhere to surfaces, multiplying there, so that close to membranes of living creatures as many as ten million germs per milliliter are found. If a surface is rinsed with fluid, as during dental treatment, germs are carried away with the water and spread in the air, affecting personnel there. Since practically everyone needs dental treatment, the risk of infections is very high.

In Taiwan, about 10% of hepatitis B cases are caused by infection of dental equipment with germs. Samples of water from treatment surfaces have tested positive for hepatitis B germs. The spread of the Aids virus by infected fluids is also a serious risk. Infection is not prevented by previous disinfection, not even by exchanging the drill head with every patient, but rather by blocking backflow of air in the dental handpiece.

A conventional dental handpiece mainly comprises a handle and a drill head, which in turn has a casing and a rotor.

U.S. Pat. No. 6,186,784 “Autoclavable dental handpiece with disposable high-speed turbine” discloses a dental handpiece as shown in FIG. 6, having two bearings a, an air turbine b, an axis c, a drill head d, a sealing ring e, two cushioning rings f, a front lid g, and a casing h. The two bearings a are placed next to the air turbine b, respectively on both sides thereof and carry the axis c. The drill head d is fastened on the axis c.

As shown in FIG. 7, a rotating movement of the axis c is driven by compressed air passing through a handle, entering the casing through an inlet h1 and hitting blades of the air turbine. Thereby torque is exerted on the axis c. The air subsequently leaves the casing h through an outlet h2 and is released back through the handle to the outside environment. Since the air turbine b rotates at high speed and the inlet h1 and the outlet h2 share a common circuit of air flow with the air turbine b, any germs in the environment, like hepatitis B germs or Aids viruses, will be sucked through the outlet h2, enter a fluid system and infect previously disinfected spaces.

### SUMMARY OF THE INVENTION

It is an object of the present invention to provide a dental hand piece which allows for no backflow of air by adapting positions of an inlet and an outlet to directions of a rotating air turbine, furthermore having increased power and producing less noise.

The present invention can be more fully understood by reference to the following description and accompanying drawings.

### DETAILED DESCRIPTION OF THE PREFERRED EMBODIMENTS

As shown in FIG. 1, the dental hand piece of the present invention mainly comprises: a casing 10; an axis 20; front and rear bearings 30, 31; a turbine 40; a front lid 50; and a drill head 60. The casing 10 has an open front end and a closed rear end. An air inlet 11 is cut into the casing 10 above the front bearing 30, and an air outlet 12 is cut into the casing 10 above the rear bearing 31. The turbine 40 has a turbine wheel 42, carrying a plurality of blades 41, and is driven by compressed air. The front bearing 30 is placed in front of the turbine 40. The axis 20 carries the turbine 40 and the front and rear bearings 30, 31 and has a front end with a central hole 21. The drill head 60 at a rear end thereof is inserted into the central hole 21. The front lid 50 seals the casing 10 at the front end thereof, with the drill head 60 passing through the front lid 50. A cushioning ring 51 and a sealing ring 52 are laid on the front bearing on a front side thereof, ensuring sealing of the interior of the casing 10 against the outside environment.

Referring to FIG. 2, the present invention works as follows. Compressed driving air passes through the air inlet 11 at the front end of the casing 10 and enters a ring channel 32 between the front bearing 30 and the casing 10. Between the drill head 60 and the air outlet 12 in insulating layer is inserted, ensuring that infected air or fluid in the outer environment are not sucked towards the air outlet 12. The driving air is led by an axially deflecting ring towards the turbine 40, hitting the turbine blades 41 and via the axis 20 driving the drill head 60. Subsequently, the driving air, now having low pressure, moves axially into a ring channel 33 between the rear bearing 31 and the casing 10 and then passes through the air outlet 12, entering a backflow conduit in a handle. Being placed at the rear end of the casing 10, opposite the drill head 60, the air outlet 12 will not readily suck in infected fluid after the drill head has stopped rotating.

Referring to FIGS. 3-5, for more effect driving of the rotational movement, the driving air hits the blades 41 of the air turbine 40 in axial direction, as led by the ring channels 32, 33 between the front and rear bearings 30, 31 and the casing 10. In addition, in various embodiments of the present invention, a front deflector 70 is placed in front of the air turbine 40, as shown in FIG. 3, or a rear deflector 80 is placed behind the air turbine 40, as shown in FIG. 4, or front and rear deflectors 70, 80 are respectively placed in front of and behind the air turbine 40, as shown in FIG. 5.

Furthermore, in a further embodiment of the present invention, a closed case of the drill head is substituted for the casing 10 and the front lid 50.

The differences in operation and effect between the present invention and conventional art are summarized as follows.

1. In the present invention, driving air is led through a ring channel. A sealing ring between the front and rear ends, in particular between the drill head and the air outlet prevents infected fluid air or fluid from being sucked into the air outlet, whereas in conventional art there is no such sealing ring, and infected air and fluid is readily sucked back.

2. In the present invention, the rotational movement of the drill head is driven by air axially hitting the air turbine, achieving maximum effectiveness. In conventional art, however, the air turbine is hit in a radial direction, resulting in less effective driving.

3. In the present invention, all blades of the air turbine are simultaneously hit by driving air, greatly increasing torque, whereas in conventional art only a small part of the blades are hit.

4. By increased effectiveness, the present invention requires a smaller air flow and less air pressure than conventional art, so that less noise is produced.

While the invention has been described with reference to preferred embodiments thereof, it is to be understood that modifications or variations may be easily made without departing from the spirit of this invention which is defined by the appended claims.

### BRIEF DESCRIPTION OF THE DRAWINGS

FIG. 1 is a perspective view of the dental hand piece of the present invention when disassembled.

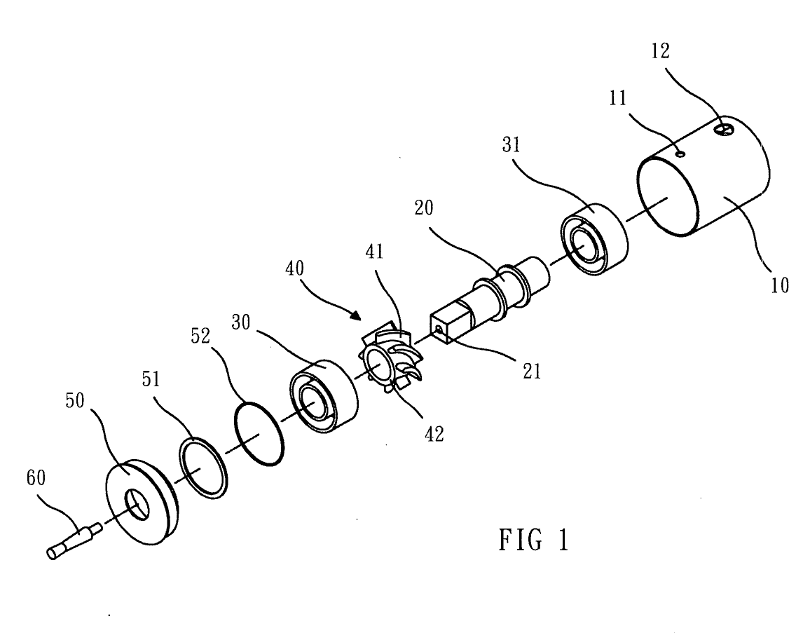

FIG. 2 is a sectional side view of the present invention.

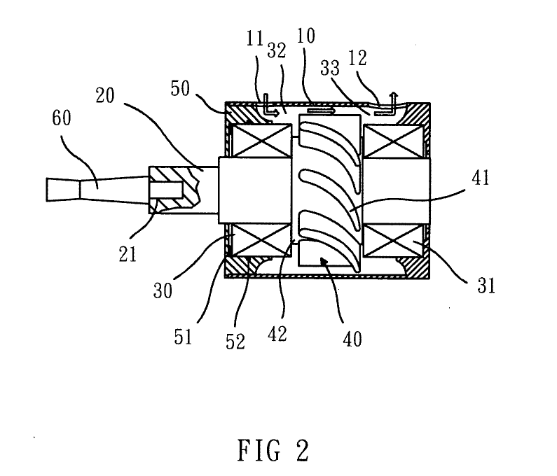

FIG. 3 is a sectional side view of the present invention in the second embodiment.

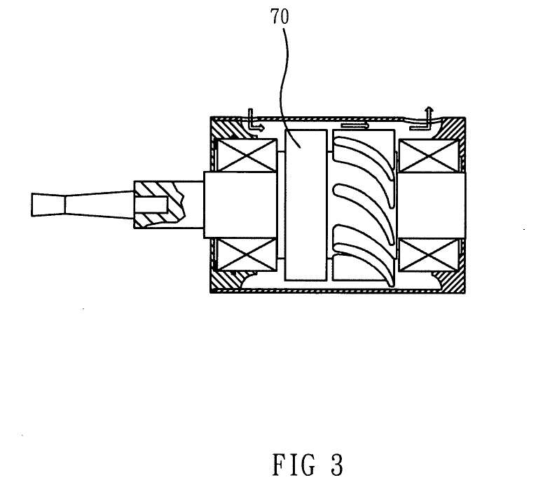

FIG. 4 is a sectional side view of the present invention in the third embodiment.

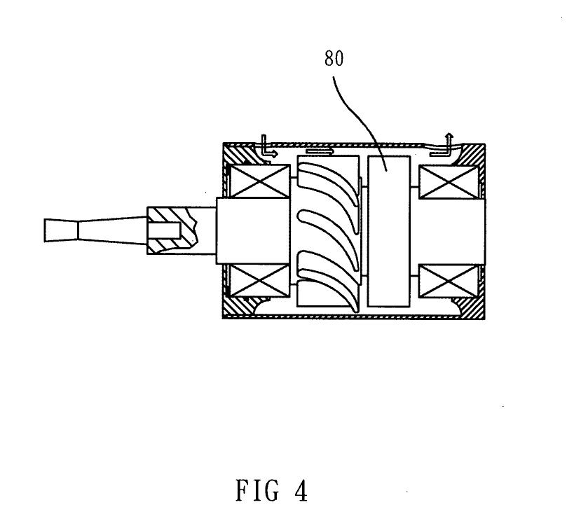

FIG. 5 is a sectional side view of the present invention in the fourth embodiment.

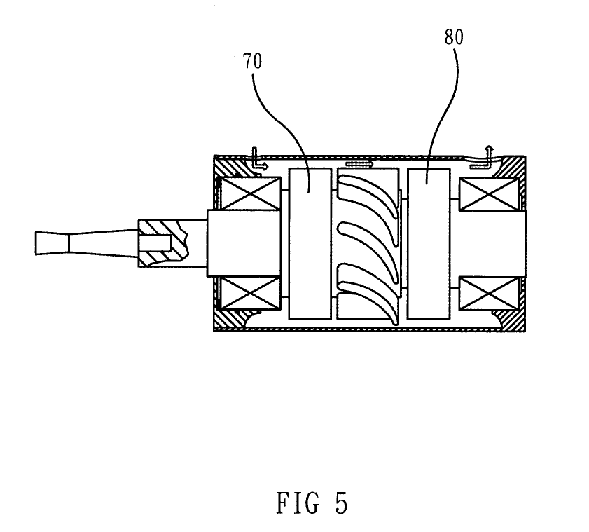

FIG. 6 is a perspective view of a conventional dental hand piece.

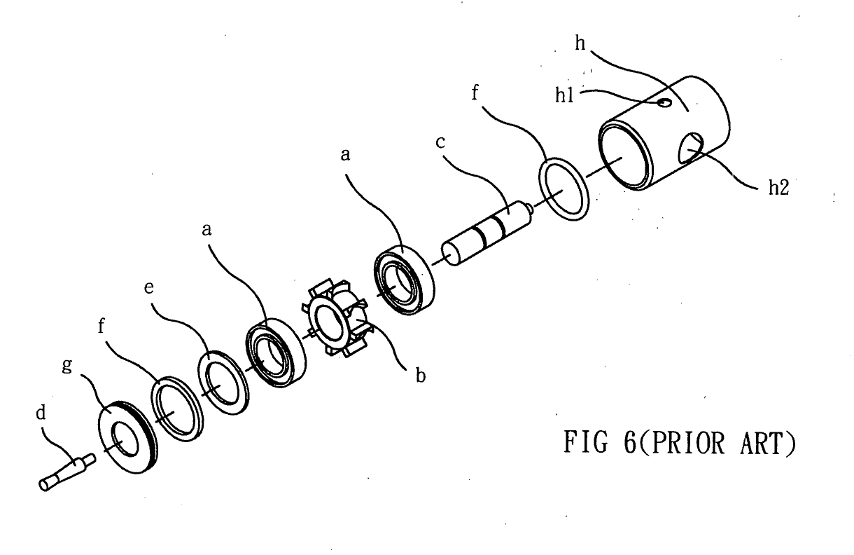

FIG. 7 is a sectional side view of a conventional dental hand piece.

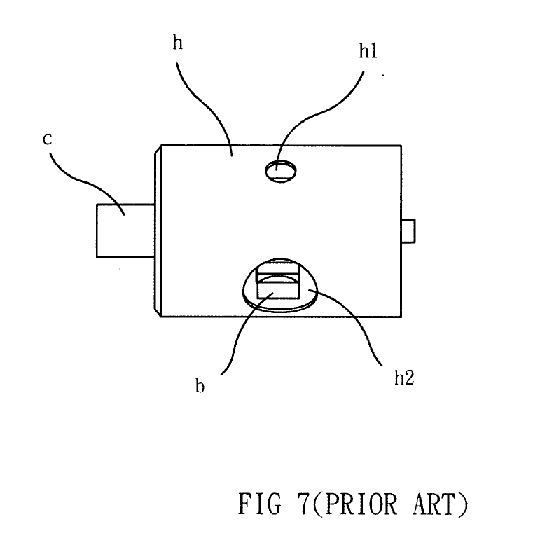

1. A dental hand piece, comprising:
a casing having an open front end, an air inlet and an air outlet;
a rear bearing inside said casing close to a rear end thereof;
an air turbine, having a wheel and a plurality of blades, performing a rotational movement driven by compressed driving air;
a front bearing inside said casing close to said front end thereof;
an axis, carrying said air turbine and said rear and front bearings, further having a front end with a central hole;
a drill head, having a rear end that is inserted into said central hole of said axis; and
a front lid, set on said open front end of said casing, sealing said casing, with said drill head passing through said front lid.

2. The dental hand piece according to claim 1, wherein said driving air is led to said plurality blades of said air turbine in an axial direction.

3. The dental hand piece according to claim 1, wherein between outer peripheries of said front and rear bearings and said casing ring-shaped spaces are left.

4. The dental hand piece according to claim 1, wherein a front deflector is placed in front of said wheel of said air turbine.

5. The dental hand piece according to claim 1, wherein a rear deflector is placed behind said wheel of said air turbine.

6. The dental hand piece according to claim 1, wherein front and rear deflectors are respectively placed in front of and behind said wheel of said air turbine.

7. The dental hand piece according to claim 1, wherein a case of said drill head is substituted for said casing and said front lid.

8. The dental hand piece according to claim 1, wherein said air inlet is cut through said casing close to said open front end thereof.

9. The dental hand piece according to claim 1, wherein said air outlet is cut through said casing close to a rear end thereof.

10. The dental hand piece according to claim 1, wherein said said air inlet reaches to a front ring channel between an outer periphery of said front bearing and said casing.

11. The dental hand piece according to claim 1, wherein said air outlet reaches to a rear ring channel between an outer periphery of said rear bearing and said casing.

12. The dental hand piece according to claim 10, wherein a sealing ring is inserted between said drill head and said air outlet, preventing any fluid or gas from said drill head to flow into said air outlet.

13. The dental hand piece according to claim 10, wherein said air inlet and said air outlet are respectively placed on two opposite sides of said air turbine.
